(19) United States
(12) Patent Application Publication
(10) Pub. No.: US 2015/0287147 A1
(43) Pub. Date: Oct. 8, 2015

(54) Apparatus and Method for Measuring Social Impact

(71) Applicant: Robert Silman, London (GB)

(72) Inventor: Robert Silman, London (GB)

(21) Appl. No.: 14/675,940

(22) Filed: Apr. 1, 2015

Related U.S. Application Data
(60) Provisional application No. 61/974,698, filed on Apr. 3, 2014.
(60) Provisional application No. 61/977,876, filed on Apr. 10, 2014.
(60) Provisional application No. 61/994,066, filed on May 15, 2014.
(60) Provisional application No. 62/005,087, filed on May 30, 2014.
(60) Provisional application No. 62/099,159, filed on Jan. 1, 2015.
(60) Provisional application No. 62/101,261, filed on Jan. 8, 2015.

(51) Int. Cl. G06Q 50/00; G06Q 30/02

(52) U.S. Cl. CPC G06Q 50/01; G06Q 30/0201

(57) ABSTRACT

A method and apparatus for providing the full spread social impact score of individual users on defined issues beyond their direct adherents via a novel social media website is described. A social impact score may be compared with that of other individuals to provide a social impact rating. For this it employs the novel means of an affiliation tree, which may include its negative counterpart, the razzy tree. The same method and apparatus can be used for determining the market impact score and rating for individual message placements.

### RELATED APPLICATIONS

This application claims the benefit of the following six U.S. Provisional Patent Applications, all of which are incorporated by reference:

1. Ser. No. 61/974,698 filed on Apr. 3, 2014.

2. Ser. No. 61/977,876 filed on Apr. 10, 2014.

3. Ser. No. 61/994,066 filed on May 15, 2014.

4. Ser. No. 62/005,087 filed on May 30, 2014.

5. Ser. No. 62/099,159 filed on Jan. 1, 2015.

6. Ser. No. 62/101,261 filed on Jan. 8, 2015.

### FIELD OF THE DISCLOSURE

The present disclosure is directed to providing the full spread social impact score of an individual via a novel social media website. The disclosure is also directed to allowing the social impact score to be compared with that of other individuals to provide a social impact score and rating.

### BACKGROUND

Over recent years there has been an increasing demand for organizations to provide evidence about their social impact. A social impact statement might detail a company's charitable giving and volunteer activities, as well as an account of how it affects social and environmental factors in the community where it operates. Despite attempts to quantify the social impact of companies and charities, it is generally a qualitative rather than a quantitative assessment.

As an example, scientists have a quantitative method for assessing the scientific impact of their research. At its crudest, it is the number of a scientist's publications. A more refined approach is to multiply the publication with the impact factor of the journal in which it is published. More recently it is acknowledged that the best scientific impact measure is to mark how far a publication has spread. For example, the “h-index” is based on the author's most cited papers and the number of citations they have received from other articles; and it provides the individual research scientist with a number (score) which quantifies the full spread of their scientific impact. This number can be compared with peers (in the same field of research) to provide a scientific impact comparison (rating).

As another example, the financial market assesses the credit-worthiness of an individual by evaluating a credit score based on a standard method of marking and calculates the credit rating based on the score's variance from a “gold” standard rather than the score of other individuals.

With the development of social media websites, it has become possible to provide a quantitative measure of the social impact of an individual. Social media websites are a means by which users create online communities to share information, ideas, personal messages, and other content. The social impact of users can, at its simplest, be measured by the number of their direct adherents, e.g. the number of “followers” on Twitter, the number of “friends” or “likes” on Facebook, the number of “views” on YouTube, the number of “contacts” on LinkedIn etc.

For example, a social media website (www.Klout.com) was developed to try and quantify the influence of users across multiple social media sites like Facebook, Twitter, LinkedIn etc. Its algorithm which provides a “Klout Score” is not readily transparent but it aspires to go beyond the number of Friends or Followers to find deeper indicators of engagement. Currently a “Klout Score” is calculated by tracking 400+ signals, using 10 different sites, over a 90 day period. Using this measure, the number of Friends on Facebook has less impact than the number of likes, shares, and comments generated by the user; and the number of Followers on Twitter has less impact than the number of retweets and mentions. The Klout Score suffers from aggregating influence from different sources with different social ambitions (e.g. LinkedIn and Instagram) and consequently lacks the means for identifying the issue(s) about which the user(s) might have influence.

By contrast, petition sites are almost exclusively about issues and about the collective influence of the users in opposing or changing something. A site (www.someofus.org) urges its users to “Take Action” against the abuses of governments and companies. Another site (www.change.org) urges its users to start a petition and then recruit supporters from Facebook, Twitter and email to support the petition. The petitioners are informed on the outcome of their petition; but there is no mechanism to quantify a petitioner's social influence based on the outcome of their action and/or their ability to mobilize other petitioners.

Accordingly, there is a need for a method and apparatus for defining the issue(s) around which the social impact is focused and a method and apparatus for measuring the social impact (focused or not) beyond the direct adherents in social media.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a flow chart to show how affiliation trees arise from a joint opinion on a single issue.

FIG. 2 is a flow chart to illustrate the hierarchical order of affiliation to an affiliation tree.

FIG. 3 is a tree chart to illustrate the hierarchical order of affiliation to an affiliation tree.

FIG. 4 is a hierarchical order score of planter and affiliates with the rating based on a percentage.

FIGS. 5 and 5A together is a hierarchical order score of planter and affiliates with the rating based on a ranking.

FIG. 6 is a flow chart for planting a Razzy Tree.

FIG. 7 is a flow chart for affiliating to a Razzy Tree.

FIG. 8 is a flow chart to illustrate the distinction between personal and public invitations to affiliate.

FIG. 9 is a tree chart to indicate the hierarchical order of affiliation with unique points of affiliation for sites of public invitation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

I. The Affiliation Network

Current social media websites may accrue data on those who frequent a user's account. Those who “link” or “friend” or “follow” or “view” or in any way interact with a user's account can be termed the user's direct adherents. Disclosed herein is a social media website which measures the social impact of users on defined issues beyond their direct adherents. For this it employs the novel means of an “affiliation tree.”

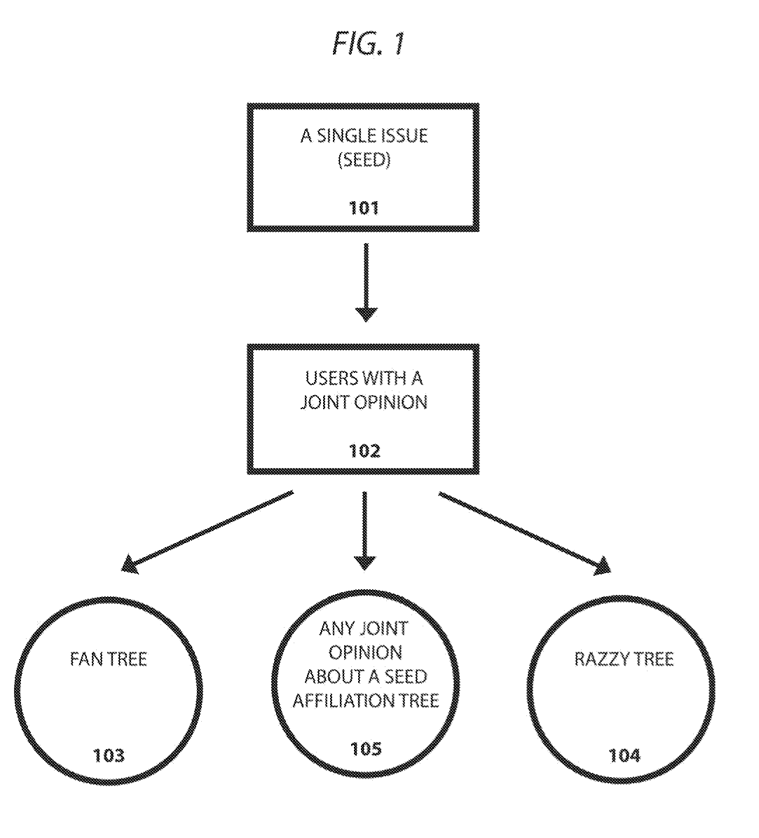

FIG. 1 illustrates how an affiliation tree grows from a single issue (seed) 101. The seed is something about which users have a joint opinion 102. The opinion might be positive, users wishing to encourage and/or support and/or promote a seed via a “Fan Tree” 103. The opinion might be negative, users wishing to criticize and/or combat and/or correct a seed via a “Razzy Tree” 104. Any joint opinion 105 about a seed can give rise to an affiliation tree.

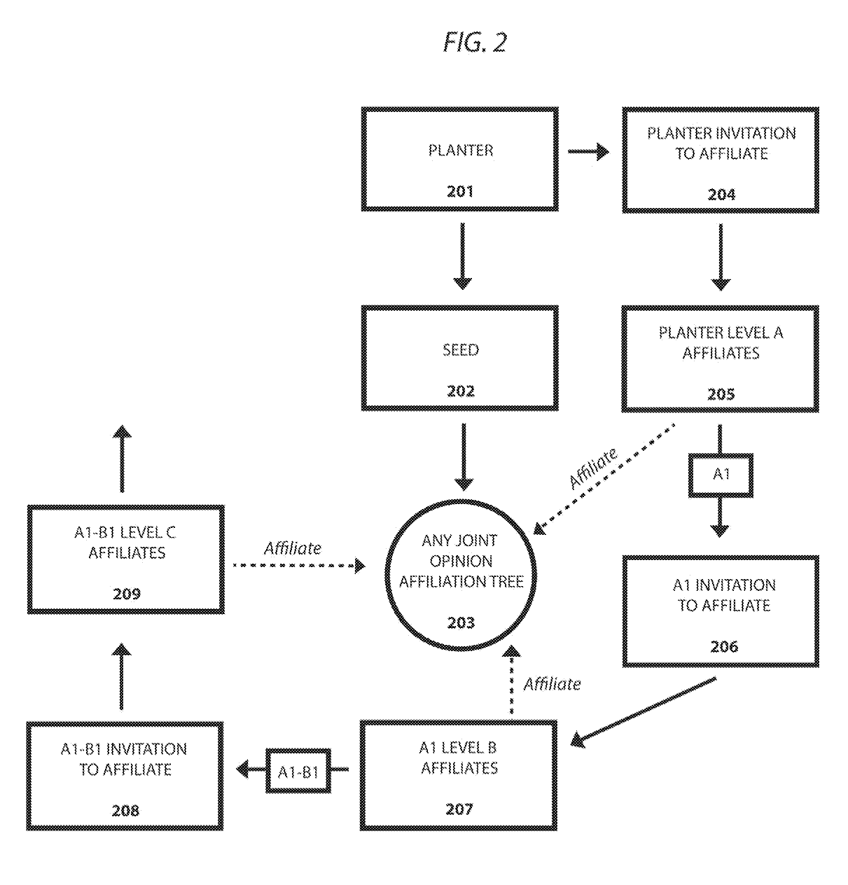

FIG. 2 illustrates how an affiliation tree allows users to measure their social impact beyond their direct adherents by tracking the hierarchical order of affiliation. A user 201 (planter) plants the seed 202 and creates an affiliation tree 203 based on the planter's opinion about the seed. The planter invites others to affiliate to the tree 204 if they share the opinion. Those who affiliate at the invitation of the Planter are level A affiliates (A1, A2, A3, A4, etc.) 205. The level A affiliates can then invite others to affiliate as level B affiliates if they share the opinion. For example if A1 invites others to affiliate to the tree 206, those who affiliate at A1's invitation are level B affiliates of A1 (A1-B1, A1-B2, A1-B3, A1-B4, etc.) 207. The level B affiliates can then invite others to affiliate as level C affiliates if they share the opinion. For example if A1-B 1 invites others to affiliate to the tree 208, those who affiliate at A1-B1's invitation are level C affiliates of A1-B1 (A1-B1-C1, A1-B1-C2, A1-B1-C3, A1-B1-C4, etc.) 209. This process can continue indefinitely without limit so long as there are users wishing and willing to affiliate.

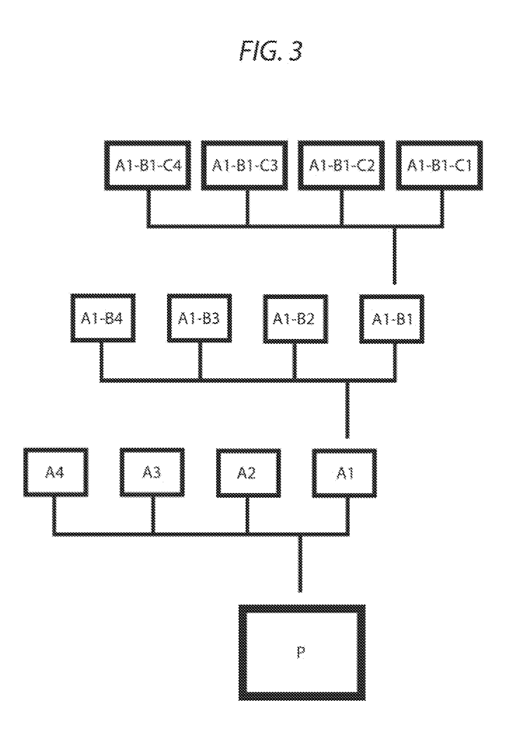

FIG. 3 illustrates the hierarchical order of an affiliation tree where the planter (P) has four affiliates at level A (A1, A2, A3, A4); where A1 has four affiliates at level B (A1-B1, A1-B2, A1-B3, A1-B4); and where A1-B1 has four affiliates at level C (A1-B1-C1, A1-B1-C2, A1-B1-C3, A1-B1-C4). The chronological order of affiliation (i.e. the sequential temporal order in which affiliation occurs) is not necessarily the same. For example A1-B1-C1 might have affiliated before A4.

A single user can affiliate to any number of affiliation trees. However, to prevent distortion of score and rating, there may be rule where a single user can only affiliate to a single affiliation tree once.

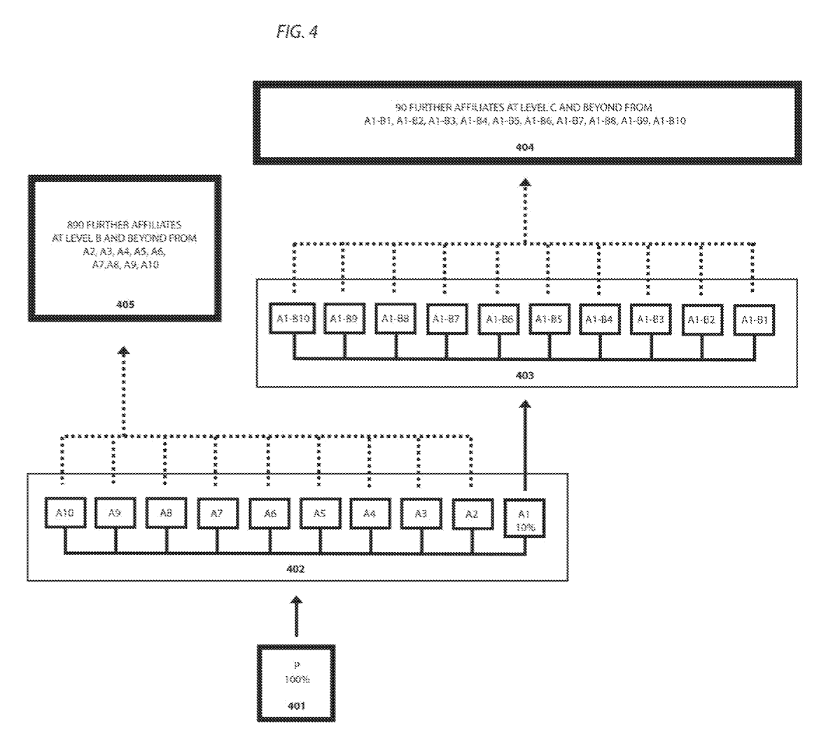

FIG. 4 illustrates how an affiliation tree might measure the social impact score on a specific issue beyond direct adherents; and how this score can provide a rating value based on the percentage of affiliates. In this example, Planter 401 has a tree with 10 direct adherents (level A affiliates) 402. The planter could have gathered these 10 direct adherents using a variety of current social media websites. As shown here, the affiliation tree allows the planter to determine the further spread of influence using a social impact score. In this case the score for the planter is 1,000 affiliates (the sum of 10 affiliates 402+the sum of 10 affiliates 403+90 affiliates 404+890 affiliates 405).

If an affiliate (A1) has 10 direct adherents (level B affiliates) 403. A1 could have gathered these 10 direct adherents using a variety of current social media websites. As shown here, the affiliation tree allows A1 to determine the further spread of his/her influence. In this case the social impact score is 100 affiliates, the sum of 10 affiliates 403+90 affiliates 404.

FIG. 4 also illustrates how an affiliation tree might measure the social impact rating based on the percentage of affiliates. Thus, the Planter (with 1,000 affiliates) has a rating of 100% of the total and A1 (with 100 affiliates) has a rating of 10% of the total.

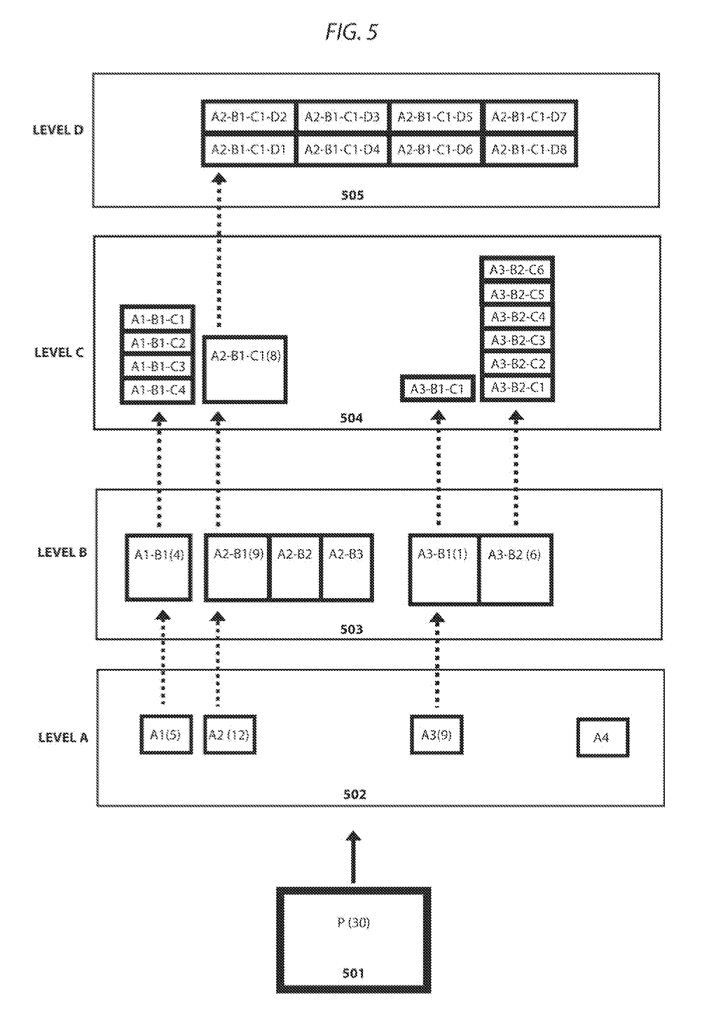

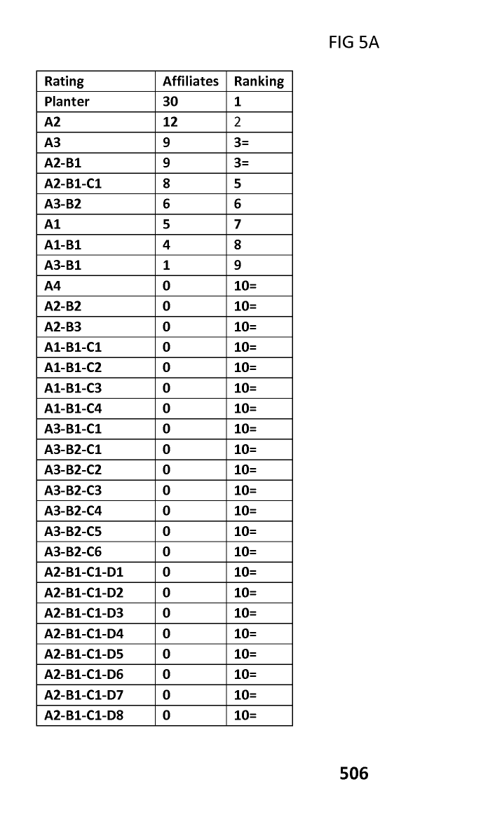

FIGS. 5 and 5A provide another example of how the rating may be related to the score to provide a ranking order. In this tree the Planter (P) has 30 total affiliates 501: 4 at level A 502, 6 at level B 503, 12 at level C 504 and 8 at level D 505. As shown here, affiliate A2-B1-C1 (at level C) 504 is ranked 5th with 8 affiliates 506 compared to affiliate A4 (at level A) 502 who is ranked 10th (equal lowest with 21 others) with 0 affiliates 506. This demonstrates that depending on the structure of the tree, affiliates with longer paths back to the planter may have a higher social impact rating than affiliates with shorter paths back to the planter.

The social impact rating can be calculated using a variety of statistical methods to compare one individual's score with others. Also, the rating can be calculated for a single issue tree and/or for several trees sharing some common issue or identity and/or for all trees. The score and the rating can also be calculated varying with time; i.e. historical and/or recent and/or contemporary.

Various statistical analytics may be used to analyze data related to the scores and ratings. Such methods may include:

1. Analysis of variance (ANOVA)

2. Chi-squared test

3. Correlation

4. Factor analysis

5. Mann-Whitney U

6. Mean square weighted deviation (MSWD)

7. Pearson product-moment correlation coefficient

8. Regression analysis

9. Spearman's rank correlation coefficient

10. Student's t-test

11. Time series analysis

12. Conjoint Analysis

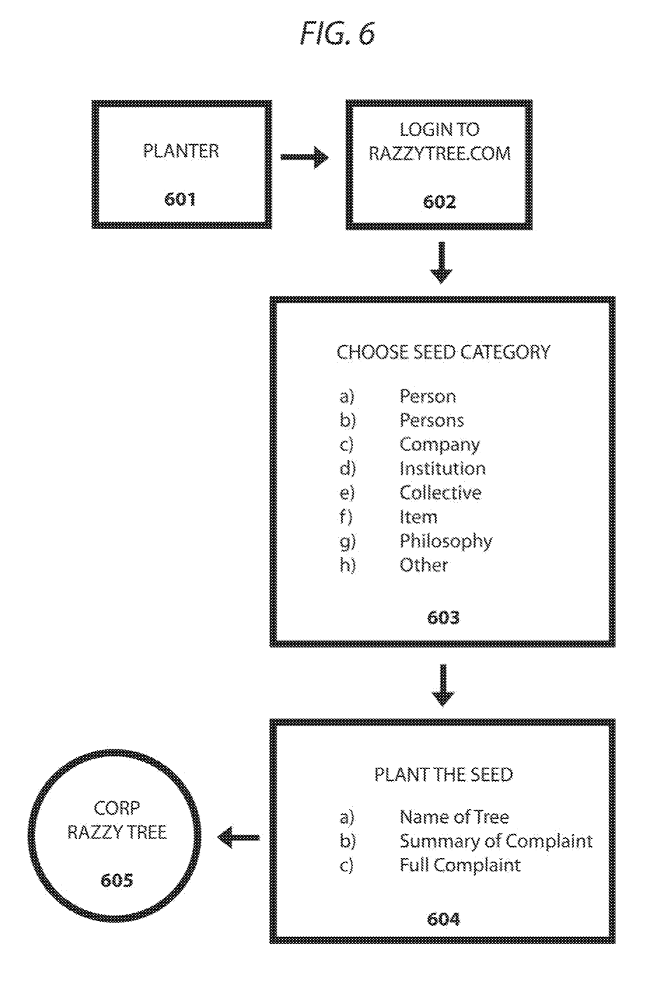

FIG. 6 provides a flow chart according to an embodiment of the invention where a user (Planter) 601 disapproves of something (Corp) and wishes to create a community to criticize, combat or correct it by creating a Corp Razzy Tree. Step 602 has P logging in (or creating an account) on a website with affiliation trees for users who dislike something (www.RazzyTree.com). Step 603 has P choosing a seed category; for example: 603a a person (celebrity, politician, artist, etc.); or 603b persons (band, quiz panel, etc.); or 603c a company (Amazon, Union Pacific Railroad, etc.); or 603d an institution (Federal Reserve Bank, Metropolitan Opera, etc.); or 603e a collective (political party, Greenpeace, etc.); or 603f an item (movie, song, dishwasher, TV show, etc.); or 603g a philosophy (religion, climate change, ethics); or 603h whatever issue category that can unify users in a common opinion. P chooses category 603c for Corp. Step 604 has P planting Corp as a seed within this category which might include inter alia 604a the name of the tree, in this case “Corp”: 604b a summary of P's complaint for Corp: and 604c a full account using text and or image and/or outside sources of P's complaint for Corp. Step 605 is the acceptance of a Corp Razzy Tree ready to receive affiliates on RazzyTree.com.

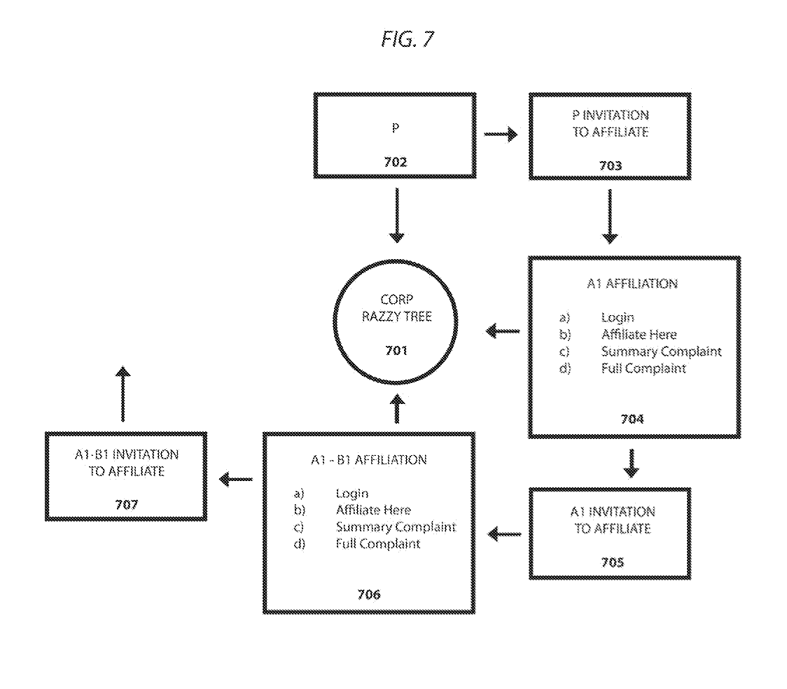

FIG. 7 provides a flow chart for how the Corp Razzy Tree 701 (also FIG. 6, 605) might grow. The Planter (P) 702 sends a personal message (e-mail, text, or other) to friends, acquaintances, colleagues urging them to adhere to the Corp RazzyTree 703. This step might involve, inter alia, the e-mail having a unique URL such that invitees who respond are identified by RazzyTree.com as being invitees of P. Step 704 has invitee A1, clicking on the unique URL in P's e-mail to A1 which brings A1 to affiliate to the Corp Razzy Tree 701 at level A. Step 704 might include inter alia: 704a A1 login on RazzyTree.com (or create an account); and 704b A1 affiliating by clicking on an “affiliate here” button; and 704c a summary of A1's complaint for Corp; and 704d a full account using text and or image and/or outside sources of A1's complaint for Corp. Step 705 has A1 sending a personal message (e-mail, text, or other) to friends, acquaintances, colleagues urging them to adhere to the Corp Razzy Tree. This step might involve, inter alia, the e-mail having a unique URL such that invitees who respond are identified by RazzyTree.com as being invitees of A1. Step 706 has invitee A1-B1, clicking on the unique URL in A's e-mail to A1-B1 which brings A1-B1 to affiliate to the Corp Razzy Tree 701 at level B. Step 706 might include inter alia: 706a A1-B1 login on RazzyTree.com (or create an account); and 706b A1-B1 affiliating by clicking on an “affiliate here” button; and 706c a summary of A1-B1's complaint for Corp; and 706d a full account using text and or image and/or outside sources of A1-B1's complaint for Corp. Step 707 has A1-B1 sending a personal message (e-mail, text, or other) to friends, acquaintances, colleagues urging them to adhere to the Corp Razzy Tree. This step might involve, inter alia, the e-mail having a unique URL such that invitees who respond are identified by RazzyTree.com as being invitees of A1-B1. This process can continue indefinitely and without limit so long as there are affiliates wishing and willing to adhere to the Corp Razzy Tree at any level at any time.

A further embodiment of the invention might define the Corp Razzy Tree (FIG. 6 605, FIG. 7 701) with greater specificity. If “Corp” has many facets and if the reason why P dislikes Corp is focused on a specific issue, P might be encouraged to define the specific issue of disapproval. It might be Corp's customer service, or Corp's products, or any other facet of Corp's business. If it was Corp's products, it might concern a single product, or a single feature of a single product. Hence Corp (or anything else) might have several trees to provide a forest of trees around different issues of Corp's (or anything else's) identity and the name of the tree would indicate the specific issue for criticism, combat or correction.

A further embodiment of the invention might have a user (U) attempting to plant a tree which already exists. RazzyTree.com might allow U to plant a tree only if it was clear that no existing tree was covering the same issue. If there was an existing tree, U might be permitted to affiliate to the existing tree at some appropriate level. If U was guided to affiliate to an existing tree without invitation from the tree's planter or existing affiliates, then U and U's affiliates might be separately scored and might not contribute to the social impact score of the planter or existing affiliates since U (and U's affiliates) did not affiliate due to their influence.

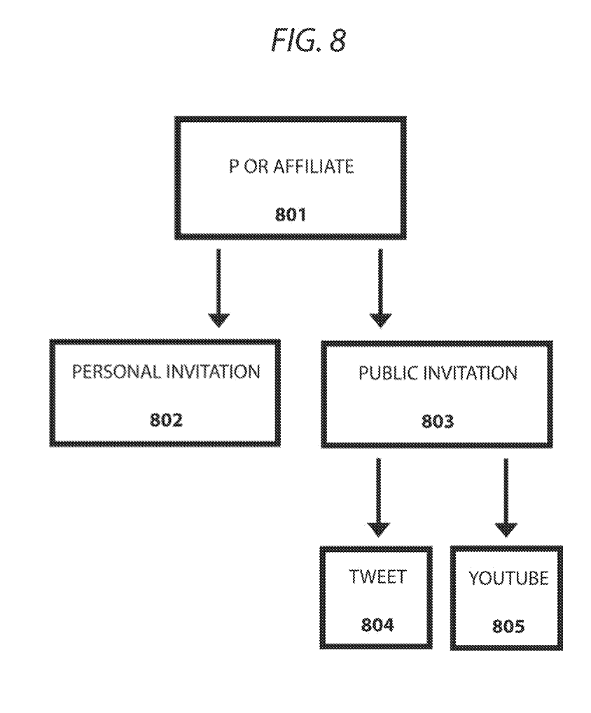

FIG. 8 provides a flow chart for a further embodiment of the invention where the invitation to affiliate might be by personal or public invitation. If P or affiliates 801 send a personal message 802 (e-mail, text, or other) to friends, acquaintances, colleagues urging them to adhere to the Corp RazzyTree, this step might involve, inter alia, the e-mail having a unique URL such that invitees who respond are identified by RazzyTree.com as being invitees of P or affiliates (FIG. 7). Likewise if P or affiliates 801 send, issue or place a public invitation 803, this step might involve, inter alia, the public invitation having a unique URL such that invitees who respond are identified by RazzyTree.com as being invitees of P or affiliates. For example if the summary by P 604b or A1 704c or A1-B1 706c was less than 140 characters, it could be sent as a tweet 804 by P or A1 or A1-B1 and so long as the tweet contained a unique URL connecting potential respondents to P or A1 or A1-B1, those respondents would affiliate at the appropriate level via P or A1 or A1-B1. Another form of public invitation might be a “click here to affiliate to my tree” icon (or message), so long as the icon (or message) contained a unique URL so that clickers would affiliate at the appropriate level via P or A1 or A1-B1. For example if P or A1 or A1-B1 had made a video criticizing Corp and placed it on YouTube 805, those clicking the icon accompanying the video on YouTube would affiliate to the tree at the appropriate level via P or A1 or A1-B1.

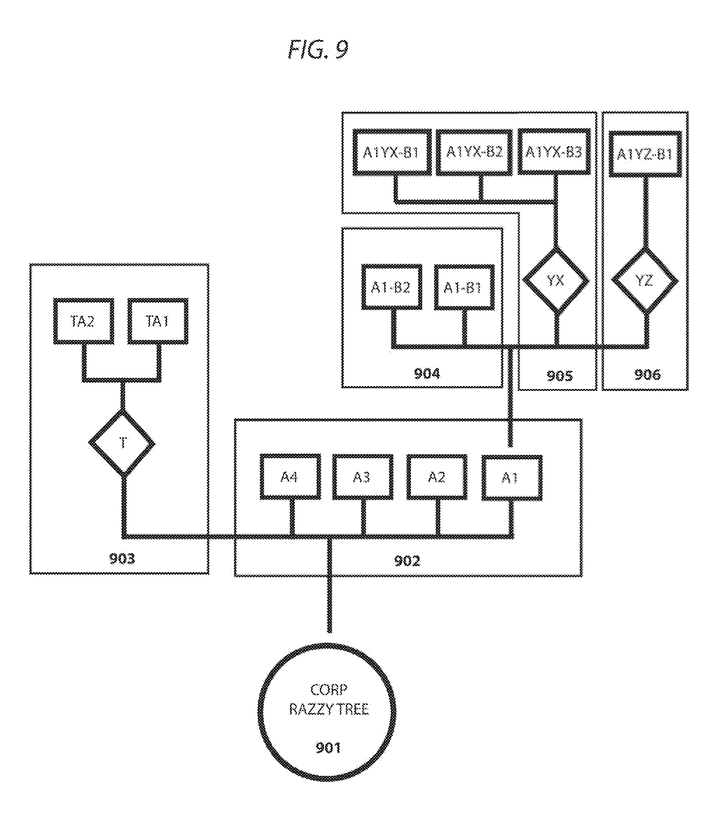

FIG. 9 provides a tree chart for a further embodiment of the invention where the invitation to affiliate by public invitation makes the source of the public invitation a unique point of affiliation on the tree. In this Corp Razzy Tree 901, P has received four affiliates from a personal invite (A1, A2, A3, A4) 902 and two affiliates from a Tweet T (TA1, TA2) 903. Affiliate A1 902 has received two affiliates from a personal invite (A1-B1, A1-B2) 904 and three affiliates from A1's video X on YouTube (A1YX-B1, A1YX-B2, A1YX-B3) 905 and one affiliate from A1's video Z on YouTube (A1YZ-B1) 906. Identifying the source of the public invitation as a unique point of affiliation on the tree does not necessarily alter the social impact and/or rating of the planter and affiliates. However it does provide quantitative information on the variance of their social impact dependent on the content and placing of the invitation. In this embodiment, the tree not only provides the social impact factor of individuals but also the market impact factor of inter-site (e.g. Twitter versus YouTube versus Facebook, etc.) and intra-site (e.g. tweet one versus tweet two; or video one versus video two; etc.) message placements. This data can be analyzed to provide a method for comparing the results of different promotional campaigns based on the same site of placement and/or the same promotional campaign based on different sites of placement and/or different promotional campaigns based on different sites of placement.

A further embodiment of the invention might result in the Corp tree no longer being valid. This could be for any number of reasons. It might be a Corp tree about a Corp product which had been withdrawn and replaced, and the tree might be deleted from the site or left to wither. It might be a Corp tree about a Corp product that had been improved, and the criticism(s) of the product from the tree might have contributed feedback leading to the improvement of the product. In this case the social impact value of the tree might be considered of greater value than that of trees that do not contribute to change; and a multiplier might be applied to the social impact scores of the affiliates, and/or the tree might cease to be interactive and, instead, maintained in a “hall of fame” for trees that had contributed to change.

A further embodiment of the invention would allow visitors to RazzyTree.com to view in real time the current status of one or all trees and/or their history (the chronological order of affiliation); to comment on the complaints of the planter and affiliates (e.g. 604b, 604c, 704c, 704d, 706c, 706d); to view the planter and affiliates scores and ratings for one or all trees; to view the shoots (the affiliates of an affiliate) and roots (the antecedents of an affiliate) for one or all trees.

A further embodiment of the invention might allow those who might be the subject (or in some way connected to the subject) of a Razzy Tree to be kept informed of the complaint(s) and offer them the opportunity to respond and/or correct the seed issue. This activity (providing data and/or offering the means to respond) might be subject to commercialization.

A further embodiment of the invention would reserve the right of the Razzy Tree site to uproot trees (and or affiliates) that were abusive (e.g. racist, sexist, bullying, etc.)

A further embodiment of the invention might be a Fan Tree site (e.g. www.FanTree.co.uk) where instead of trees designed to criticize, combat and correct the seed, there are trees to approve support and encourage a seed. This embodiment would offer talented artists a novel means to create, develop, enlarge and maintain a fan base. It would also allow fans a new vehicle by which they can express their allegiance to those they like. It could also offer a novel means to promote a product and/or communicate with a targeted public and/or analyze the efficacy of different promotional campaigns. As such, a fan tree site might be subject to commercialization through subscription (e.g. fan trees below a certain size at no cost and then a sliding scale of subscription to maintain fan trees of increasing size) as well as commercialization by providing data and/or the means to communicate with the fan base. A further embodiment of a Fan Tree site might require that if the seed is something owned and/or controlled by someone or some institution, then the seed can only be planted by the rights holder or authorized institution. Under this embodiment there would be a process of verification whereby the planter would acknowledge their “right” to plant the seed and if the acknowledgement was contested the Fan Tree site would have the right to uproot the tree.

A further embodiment of the invention would be a site (e.g. www.affiliationtree.com) which has Razzy Trees and Fan Trees and other “any joint opinion about a seed” trees. Such a site might even combine trees so that if a seed had both a Fan Tree and a Razzy Tree the two trees might interact.

II. Marketing Applications

Affiliation Trees may generate new social media websites and new marketing and promotional tools. As shown below, commercialization may occur via a) the RazzyTree; b) the FanTree; c) Affiliation Trees as add-ons to existing sites; and d) unique features of any Affiliation Tree in exchange for unique market information.

A. RazzyTree

The RazzyTree is an entirely novel means for a Planter to rapidly vent his/her rage against someone/something by soliciting the support of affiliates; and/or affiliates to agree with the Planter by affiliating to the RazzyTree and soliciting further affiliates; and/or Planter and affiliates pressuring to remedy what they dislike.

The source of monetization for a RazzyTree would be the Seed, particularly if the Seed is a company, institution or collective. Such Seeds would be keen to garner information as to what aspect of their operation is generating criticism; what are the specific complaint(s); what extent these complaints are growing. The obvious forms of commercialization are to offer timely detailed reports on “what complaints are growing” in their domain (for a price); and if the complaints are remedied, to communicate (for a price) the remedy to the complainants. In this last example, the complainants might be provided with an opportunity to vote on the remedy; and, if it was accepted as a true remedy, the tree might be deleted from the site; or left to wither; or the tree might cease to be interactive and, instead, be maintained in a “hall of fame” for trees that had contributed to change; or if the remedy resulted in a desirable product/service, the RazzyTree might even take on new life as a FanTree.

B. FanTree

The FanTree is an entirely novel means for talented artists to create, develop, enlarge and maintain a fan base; and/or fans to express their allegiance to those artists of talent they admire; and/or corporations/institutions to create, develop, enlarge and maintain a customer base for their products/services; and/or a customer base to express their allegiance to products/services of corporations/institutions they like.

Unlike a RazzyTree, a FanTree could be of monetary value to the Planter, especially if the site was designed so that the Planter was the rights holder of the Seed. The FanTree would be a means for the Planter to spread news about the Seed to increase sales and/or exposure. It could also be of value as a means of communicating with the customer base: e.g. if the FanTree was a book, informing the affiliates of a new edition or a new book or an upcoming book signing: if the FanTree was a band, informing the affiliates of a new album or a new tour; etc.

For these reasons a FanTree site might be monetized as a subscription site: free for Planters who have planted FanTrees consisting of less than (say) 100 fans so as to allow every Planter who thinks they have a viable Seed to attempt to grow it without financial cost; and then a sliding scale of “garden maintenance fees” (i.e. annual subscription) for FanTrees of increasing size.

C. Licensing

Affiliation Trees may also prove attractive in enhancing some existing forms of social linkage; i.e. a license to intellectual property for others to use. For example:

1. LinkedIn/Facebook

LinkedIn has “connections” and Facebook has “friends” and “likes”. It is not too difficult to see that these forms of social networking might be enhanced by introducing a FanTree as a form of connectivity.

2. Amazon/Tripadvisor

Amazon has “reviewers” who are keen to be recognized. At the moment their only form of recognition is the number of reviews they provide and the number of people who find their reviews “useful”. Amazon also has a star rating system for every product; 5 the best, 1 the worst. It is quite possible to imagine that if a reviewer gives a product 5 stars, the reviewer could be affiliated to that product's FanTree (or whatever name Amazon might choose to call it) and the reviewer be provided with the FanTree model so as to bring others to like what the reviewer likes. It is also possible to imagine the reverse. If a reviewer gives a product 1 star, the reviewer could be affiliated to that product's RazzyTree (or whatever name Amazon might choose to call it) and the reviewer be provided with the RazzyTree model to bring others to dislike what the reviewer dislikes. In other words for almost every product on Amazon, there could be an accompanying FanTree and/or RazzyTree.

Exactly the same principle would apply to TripAdvisor (and sites like it) with the possibility of FanTrees and RazzyTrees, by whatever name, alongside each hotel, restaurant etc. in user guides.

D. Unique Market Information

Affiliation Trees represent a new marketing and promotional tool and, as such, can generate unique market information. What follows are examples of what could serve as commercially viable unique market information.

1. Focused Focus Groups

It is quite possible that there might be a FanTree and a RazzyTree for the same product/service; just like with sites such as Amazon or Tripadvisor, there is often a spectrum from five stars (excellent) to one star (terrible) for the same object. However, distilling the raves from a FanTree and the rants from a RazzyTree into a report, and tracking how the raves and the rants might alter with time, would provide spontaneous focused data as to what customers love and hate about a product/service which could be sold to the provider of the product/service.

2. Market Impact Score and Market Impact Rating

A unique URL embedded as an icon in a promotional site (see section 4 b ii Growing a “Corp” Razzy Tree by public invitation) which grows thousands of Shoots is of greater value (in sales and marketing terms) than a unique URL embedded in some other promotional site from which hardly any Shoots grow. In this case the Market Impact Score and Rating for different promotional campaigns is dependent on where the promotional message was embedded. The only difference is calculating the score and rating from Shoots which are generated from the points of embedment of message invites rather than from the point of affiliation of individuals.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An apparatus comprising:
an initiator group, the initiator group having at least one initiator member;
a first group, the first group having at least one first group member;
a second group, the second group having at least one second group member;
a third group, the third group having at least one third group member;
a first network related to an issue of interest to the at least one initiator member;
a first invitation from the at least one initiator member to the at least one first group member to affiliate with the first network;
a first affiliation between the at least one first group member and the at least one initiator member;
a second invitation from the at least first group member to the at least one second group member to affiliate with the first network;
a second affiliation between the at least one second group member and the at least one first group member;
a third invitation from the at least second group member to the at least one third group member to affiliate with the first network;
a third affiliation between the at least one third group member and the at least one second group member;
an initiator social impact score, the initiator social impact score summing at least the number of first affiliations made at the invitation of the at least one initiator, the number of second affiliations made at the invitation of the at least one first group member and the number of third affiliations made at the invitation of the at least one second group member;
a first member social impact score, the first member social impact score summing at least the number of second affiliations made at the invitation of the at least one first group member and the number of third affiliations made at the invitation of the at least one second group member;
a second member social impact score, the second member social impact score summing at least the number of third affiliations made at the invitation of the at least one second group member;
wherein each of the at least one initiator member, each of the at least one first group member, each of the at least one second group member and each of the at least one third group member may affiliate with the first network a maximum of one time.

2. The apparatus as in claim 1, further comprising:
a first network member selected from a group consisting of the at least one initiator member, the at least one first group member, the at least one second group member and the at least one third group member;
a first network social impact score that is associated with the first network member selected from a group consisting of the initiator social impact score, the first member social impact score and the second member social impact score;
a second network having at least one second network member with a second social impact score,
and wherein the second network member is also a first network member;
a total social impact score of the first network member comprising the sum of the first social impact score and the second social impact score.

3. The apparatus as in claim 1, wherein the at least one initiator member has a positive view of the issue of interest.

4. The apparatus as in claim 1, wherein the at least one initiator member has a negative view of the issue of interest.

5. The apparatus as in claim 3, further comprising:
a first network member selected from a group consisting of the at least one initiator member, the at least one first group member, the at least one second group member and the at least one third group member;
a first network social impact score that is associated with the first network member selected from a group consisting of the initiator social impact score, the first member social impact score and the second member social impact score;
a second network having at least one second network member with a second social impact score,
and wherein the second network member is also a first network member;
a total social impact score of the first network member comprising the sum of the first social impact score and the second social impact score.

6. The apparatus as in claim 4, further comprising:
a first network member selected from a group consisting of the at least one initiator member, the at least one first group member, the at least one second group member and the at least one third group member;
a first network social impact score that is associated with the first network member selected from a group consisting of the initiator social impact score, the first member social impact score and the second member social impact score;
a second network having at least one second network member with a second social impact score,
and wherein the second network member is also a first network member;
a total social impact score of the first network member comprising the sum of the first social impact score and the second social impact score.

7. The apparatus as in claim 1, further comprising a comparison of the initiator social impact score and an affiliate social impact score selected from a group consisting of the first member social impact score and the second member social impact score.

8. The apparatus as in claim 2, further comprising a comparison of a plurality of total social impact scores.

9. The apparatus as in claim 5, further comprising a comparison of plurality of total social impact scores.

10. The apparatus as in claim 6, further comprising a comparison of plurality of total social impact scores.

11. An apparatus comprising:
an initiator group, the initiator group having at least one initiator member;
a first group, the first group having at least one first group member;
a second group, the second group having at least one second group member;
a third group, the third group having at least one third group member;
a network related to an issue of interest to the at least one initiator member;
a first initiator invitation from the at least one initiator member to affiliate with the network;
a first affiliation between the at least one first group member and the at least one initiator member in response to the first initiator invitation;
a first affiliate invitation from the at least first group member that affiliated in response to the first initiator invitation to the at least one second group member to affiliate with the network;
a second affiliation between the at least one second group member and the at least one first group member that affiliated in response to the first initiator invitation;
a second affiliate invitation from the at least second group member to the at least one third group member to affiliate with the network;
a third affiliation between the at least one third group member and the at least one second group member and the at least one first group member that affiliated in response to the first initiator invitation;
a second initiator invitation from the at least one initiator member to affiliate with the network;
a fourth affiliation between the at least one first group member and the at least one initiator member in response to the second initiator invitation;
a third affiliate invitation from the at least first group member that affiliated in response to the second initiator invitation to the at least one second group member to affiliate with the network;
a fifth affiliation between the at least one second group member and the at least one first group member that affiliated in response to the second initiator invitation;
a fourth affiliate invitation from the at least second group member to the at least one third group member to affiliate with the network;
a sixth affiliation between the at least one third group member and the at least one second group member and the at least one first group member that affiliated in response to the second initiator invitation;
an initiator first invitation market impact score, summing at least the number of first affiliations made at the first invitation of the at least one initiator, the number of second affiliations made at the invitation of the at least one first group member that affiliated in response to the first initiator invitation and the number of third affiliations made at the invitation of the at least one second group member at the invitation of the at least one first group member that affiliated in response to the first initiator invitation;
an initiator second invitation market impact score, summing at least the number of fourth affiliations made at the second invitation of the at least one initiator, the number of fifth affiliations made at the invitation of the at least one first group member that affiliated in response to the second initiator invitation and the number of sixth affiliations made at the invitation of the at least one second group member at the invitation of the at least one first group member the affiliated in response to the second initiator invitation;
wherein each of the at least one initiator member, each of the at least one first group member, each of the at least one second group member and each of the at least one third group member may affiliate with the network a maximum of one time.

12. The apparatus as in claim 11, further comprising a comparison of an initiator first invitation market impact score and an initiator second invitation market impact score.

13. An apparatus comprising:
an initiator group, the initiator group having at least one initiator member;
a first group, the first group having at least one first group member;
a second group, the second group having at least one second group member;
a third group, the third group having at least one third group member;
a network related to an issue of interest to the at least one initiator member;
an initiator invitation from the at least one initiator member to affiliate with the first network;
a first affiliation between at least one first group member and the at least one initiator member in response to the initiator invitation;
a first invitation from the at least first group member that affiliated in response to the initiator invitation to the at least one second group member to affiliate with the network;
a second affiliation between the at least one second group member and the at least one first group member in response to the first invitation;
a second invitation from the at least second group member to the at least one third group member to affiliate with the network;
a third affiliation between the at least one third group member and the at least one second group member that affiliated with the network in response to the first invitation;
a third invitation from the at least first group member that affiliated with the network in response to the initiator invitation to the at least one second group member to affiliate with the network;
a fourth affiliation between the at least one second group member and the at least one first group member in response to the third invitation from the at least first group member;
a fourth invitation from the at least second group member to the at least one third group member to affiliate with the network;
a fifth affiliation between the at least one third group member and the at least one second group member that affiliated with the network in response to the fourth invitation;
a first group first invitation market impact score summing at least the number of second affiliations and the number of third affiliations;
a first group second invitation market impact score summing at least the number of fourth affiliations and the number of fifth affiliations;
wherein each of the at least one initiator member, each of the at least one first group member, each of the at least one second group member and each of the at least one third group member may affiliate with the network a maximum of one time.

14. The apparatus as in claim 13, further comprising a comparison of a first group first invitation market impact score and a first group second invitation market impact score.
